(19) United States
(12) Patent Application Publication
(10) Pub. No.: US 2010/0247424 A1
(43) Pub. Date: Sep. 30, 2010

(54) HYDROGEN STORAGE IN NANOPOROUS INORGANIC NETWORKS

(75) Inventors: Samuel S. Mao, Castro Valley, CA (US); Xiaobo Chen, Albany, CA (US); Arlon Hunt, Kensington, CA (US)

Correspondence Address: Weaver Austin Villeneuve & Sampson LLP, P.O. BOX 70250, OAKLAND, CA, 94612-0250, US

(73) Assignee: THE REGENTS OF THE UNIVERSITY OF CALIFORNIA, Oakland, CA (US)

(21) Appl. No.: 12/599,408

(22) PCT Filed: May 22, 2008
(86) PCT No.: PCT/US08/64588

§ 371 Date: Dec. 9, 2009

Related U.S. Application Data
(60) Provisional application No. 60/939,829, filed on May 23, 2007.

(51) Int. Cl. C01B 3/02; B01J 21/08; B01J 8/02; B01J 23/78

(52) U.S. Cl. 423/648.1; 502/252; 422/211; 977/773

(57) ABSTRACT

Materials based on nanoporous inorganic network materials and associated devices and methods for solid state storage of hydrogen and other gases are capable of greater storage capacity with improved availability of stored gases. Coated active oxide networks such as TiO₂ and SiO₂ aerogels as network materials are coated with selected inorganic catalytic materials and/or high gas storage capacity materials. A variety of coated nanoporous inorganic network materials are disclosed with material formulas X—Y; X being an inorganic coating, including one or more of nanoparticles, layered structure materials and intercalated materials; and Y being the inorganic nanoparticle network. At least one of the network and the coating comprises a catalyst for enhanced sorption of a gas to be stored, such as hydrogen.

### CROSS-REFERENCE TO RELATED APPLICATIONS

This application builds claims priority to U.S. Provisional Patent Application No. 60/939,829, titled HYDROGEN STORAGE IN NANOPOROUS INORGANIC NETWORKS, filed May 23, 2007, the disclosure of which is incorporated herein by reference in its entirety and for all purposes.

### STATEMENT OF GOVERNMENTAL SUPPORT

The invention described and claimed herein was made at least in part utilizing funds supplied by the U.S. Department of Energy under Contract No. DE-AC02-05CH11231. The Government has certain rights in this invention.

### BACKGROUND OF THE INVENTION

This invention relates generally to hydrogen storage, and, more specifically, to nanoporous inorganic network materials that can store hydrogen at various temperatures and under safe pressures.

Hydrogen has received much recent attention owing to its potential as an alternative to fossil fuel. Not only is it an abundant element, hydrogen offers an environmentally friendly energy source which produces only harmless H₂O as a byproduct after burning with oxygen. Efficient storage of hydrogen has been considered the most challenging task for the hydrogen economy. Current hydrogen storage approaches include using a heavily insulated cryogenic container to store liquid hydrogen or pressurizing hydrogen gas, which is inefficient due to the very low density of the H₂ gas and large volume needed for storage.

Solid-state hydrogen storage is attractive from a technological point of view, but has encountered tremendous challenges in storage capacity and kinetics. Hydrogen sorption, whether chemisorption of dissociated atomic hydrogen or van der Waals type weak physisorption of molecular hydrogen, depends on material-specific attractive forces that vary as a function of distance from the storage material surface. Carbon materials and metal hydrides, including complex hydrides, represent two distinctive categories of candidate materials for solid-state hydrogen storage that have been the focus of intensive research.

For carbon materials such as activated carbon and carbon nanotubes, the ultimate hydrogen storage capacity remains to be realized. On the other hand, many metal hydrides have exhibited impressive hydrogen storage capacities, e.g., 7.6 weight % for ionic magnesium dihydride, MgH₂. However, a primary barrier for direct use of metal hydrides is their high thermodynamic stability, resulting in a high desorption enthalpy and the need for a high and therefore unfavorable desorption temperature (e.g., 300° C. for MgH₂). Additionally, hydride formation from bulk metallic materials is usually a very slow process. Numerous approaches such as ball milling and alloying have been attempted to improve the kinetics of hydrogen sorption in metal hydrides. For instance, Mg₂Ni alloy can form a ternary complex hydride rapidly, with Ni serving as the catalyst for the dissociation of molecular hydrogen.

More recently, metal-organic frameworks have emerged as an important class of solid-state hydrogen storage materials due to their low density (e.g., less than 1.00 g/cm³) and high specific surface area (e.g., greater than 500 m²/g), as well as the possibility of using these materials to design functionalized porous structures. For example, a metal-organic framework of composition Zn₄O(BDC)₃ (BDC=1,4-benzenedicarboxylate) with a cubic three-dimensional extended porous structure has been shown to adsorb hydrogen up to 4.5 weight % at cryogenic temperature and 1.0 weight % at room temperature with a pressure of 20 bar. Comprehensive theoretical calculations have been used to identify the adsorption sites around each Zn₄O cluster and provide insight into hydrogen interaction with the framework.

### SUMMARY OF THE INVENTION

The present invention provides new materials and associated devices and methods for solid state storage of hydrogen and other gases. The materials of the invention are capable of greater storage capacity with improved availability of stored gases.

In one aspect, the invention relates to a hydrogen storage material, comprising an inorganic nanoparticle network and an inorganic coating on the inorganic nanoparticle network, wherein at least one of the network and the coating comprises a catalyst for sorption of hydrogen. The material may also be configured for the storage of other gases, such as ammonia and carbon dioxide with selection of appropriate materials network and coating materials.

Coated active oxide networks such as TiO₂ and SiO₂ aerogels as network materials are coated with selected inorganic catalytic materials and/or high gas storage capacity materials. A variety of coated nanoporous inorganic network materials are disclosed with material formulas X—Y; X being an inorganic coating, including one or more of nanoparticles, layered structure materials and intercalated materials; and Y being the inorganic nanoparticle network. At least one of the network and the coating comprises a catalyst for sorption of a gas to be stored, such as hydrogen.

Associated devices for gas storage and methods of making gas storage materials and storing gases are also provided.

These and other aspects of the present invention are described in more detail in the description that follows.

### BRIEF DESCRIPTION OF THE DRAWINGS

The foregoing aspects and others will be readily appreciated by the skilled artisan from the following description of illustrative embodiments and the accompanying drawings.

FIGS. 1-4 are schematic illustrations of four strategies of all-inorganic coated active oxide networks for hydrogen storage in accordance with embodiments of the present invention. The ultralow-density TiO₂ nanoparticle network is used as an example.

FIG. 5A is a schematic illustration of a PVD reactor and process in accordance with embodiments of the present invention.

FIG. 5B is a schematic illustration of a CVD reactor and process in accordance with embodiments of the present invention.

FIGS. 6A and B are a schematic illustrations of hydrogen storage devices, according to embodiments of the invention.

FIG. 7 is a graph showing hydrogen concentration as a function of pressure at room temperature for a nanoporous MgNi:SiO₂ network material in accordance with an embodiment of the present invention.

### DETAILED DESCRIPTION OF SPECIFIC EMBODIMENTS

Reference will now be made in detail to specific embodiments of the invention. Examples of the specific embodiments are illustrated in the accompanying drawings. While the invention will be described in conjunction with these specific embodiments, it will be understood that it is not intended to limit the invention to such specific embodiments. On the contrary, it is intended to cover alternatives, modifications, and equivalents as may be included within the spirit and scope of the invention as defined by the appended claims. In the following description, numerous specific details are set forth in order to provide a thorough understanding of the present invention. The present invention may be practiced without some or all of these specific details. In other instances, well known process operations have not been described in detail in order not to unnecessarily obscure the present invention.

### Introduction

The present invention provides new gas storage material technology. Particular embodiments of the invention are based on coated active oxide networks (referred to herein as CAON). Ultralow-density (e.g., about 0.1 g/cm³) solid-state oxide nanostructures (e.g., TiO₂, SiO₂, etc. aerogels) as network materials are coated with selected catalytic metal and/or high gas storage capacity layers. In various embodiments of the invention, a variety of coated nanoporous inorganic network materials with material formulas X—Y; X being an inorganic coating, including one or more of nanoparticles, layered structure materials and intercalated materials; and Y being the inorganic nanoparticle network. At least one of the network and the coating comprises a catalyst for enhancing sorption of a gas to be stored, such as hydrogen. In various embodiments, either of the network or the coating may provide storage capacity, catalysis, or both.

An example class of these materials is X—Y networks, where X represents a metallic catalyst and Y represents an oxide aerogel. Specific examples include Pd—TiO₂ aerogel or MgNi—SiO₂ aerogel. The inorganic nanoparticle network can be coated to form materials in accordance with the present invention by any of a variety of strategies described herein.

### Materials

Silica aerogel was first created by Steven Kistler in 1931. Since then, aerogel has been made of many other materials, such as alumina, chromia, tin oxide, titanium oxide, and carbon. Typical aerogels are between 95% and 99.5% porous. Aerogels are an example of an inorganic nanoparticle network material (nanoporous network of inorganic nanoparticles). Individual network particles can have a diameter in the range of about 1-10 nm, or 3-5 nm, for example 5 nm. These materials have ultralow-density (e.g., about 0.1 g/cm³ for silica aerogel) and extremely high surface area. The very large free volume in nanoporous oxide aerogels provides ample space for material modification to further increase the gas storage capacity through either a physisorption (physical binding to the material) or combined with a chemisorption (chemical binding to the material) mechanism.

Using TiO₂ aerogel as an example of an inorganic nanoparticle network, materials in accordance with the present invention can be characterized as X—TiO₂ networks, where X represents an inorganic coating, including one or more of nanoparticles, layered structure materials and intercalated materials. Examples include carbon, metallic, hydride or amide compounds which can be coated on the TiO₂ network by any of the following strategies:

According to a first strategy, the inorganic nanoparticle network, in this case a nanostructured titanium oxide network, is the primary hydrogen storage material. The network may take any suitable form. The X coating, nanoparticles of a catalyst such as MgNi, Pd, Pt, Au, Ca, Ni or Ti, catalyzes dissociation of molecular hydrogen and promotes enhanced chemisorption of hydrogen into the TiO₂ network through surface diffusion. Pd—TiO₂ for hydrogen storage is a particular example of this type of material, referred to herein as CAON-1 materials.

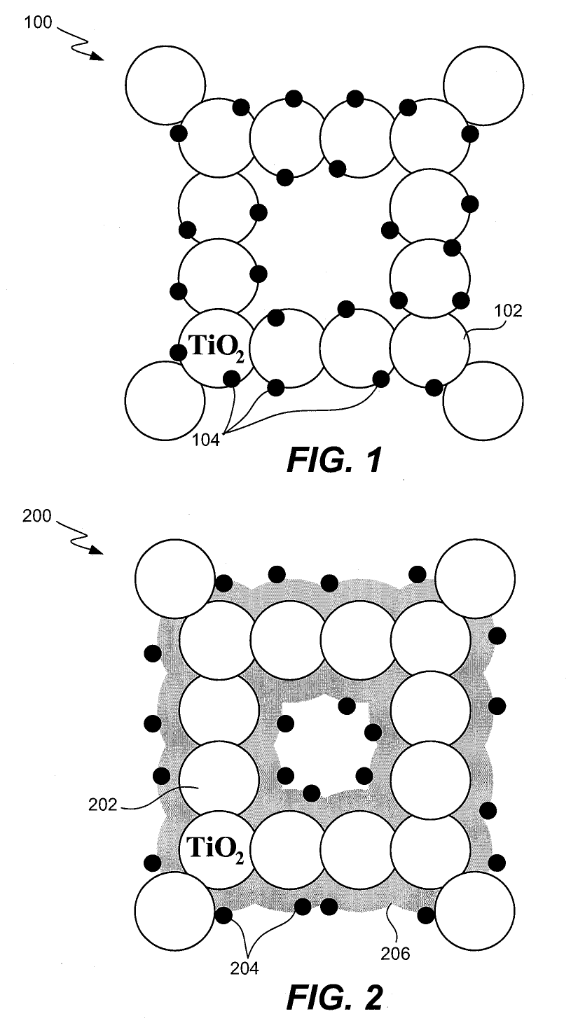

FIG. 1 illustrates an inorganic nanoparticle network 102 coated with catalyst nanoparticles 104 forming a CAON-1 gas storage material 100 in accordance with this first strategy of the present invention. The nanoparticles 104 coat the network in an amount sufficient to enhance chemisorption of the gas to be stored (e.g., hydrogen) into the inorganic nanoparticle (e.g, TiO₂ aerogel) network through surface diffusion. In a particular embodiment, about 1 weight % of Pd is suitable to enhance the chemisorption of hydrogen into a TiO₂ aerogel.

According to a second strategy, depicted in FIG. 2, the inorganic nanoparticle network 200 (nanostructured TiO₂; e.g., TiO₂ aerogel) acts as the template for a coating of X 206, which includes a graphite-like carbon or other layered structure materials, such as layered hydride or metals, in which a gas, such as hydrogen, can be stored via surface diffusion, and catalyst nanoparticles 204 deposited either during or after coating the inorganic nanoparticle network with layer-structured material. These materials are referred to herein as CAON-2 materials.

In CAON-2 materials, the inorganic nanoparticle network is utilized as the “template” and a coated film rather than the inorganic nanoparticle network acts as the gas (e.g., hydrogen) receptor through a surface diffusion mechanism. In a specific embodiment, a silicon or titanium oxide network is coated with graphite-like carbon thin film. The film coatings may have a thickness of about 1-10 nm, for example. Catalyst nanoparticles are then deposited on the carbon film after its deposition.

According to a third strategy, depicted in FIG. 3, the X coating 304 is the primary hydrogen storage material for which an inorganic nanoparticle network 302 having catalytic activity, such as nanostructured ultralow-density TiO₂ networks, acts as the catalyst to enhance chemisorption in X to form a gas storage material 300. These materials are referred to herein as CAON-3 materials. Suitable examples of X in this context include metal hydrides in the form of nanoparticles or micro-scale coatings deposited on the TiO₂ network. The nanoparticles 304 ideally coat the network in as high a density as possible in order to maximize the amount of X available as gas storage capacity.

In this embodiment, in addition to serving as a support structure and nano-separation matrix, the network provides catalysis for the gas (e.g. hydrogen) storage in the X coating. TiO₂ is a desirable network material for implementation of this strategy because it is innately catalytic. For less or non-catalytic network materials, e.g., SiO₂, catalysts can also be deposited into the network structure to provide a similar effect.

In specific embodiments of CAON-3 materials, where the coating is the primary hydrogen storage medium for which nanostructured oxide networks would act as the catalyst as well as the support, TiO₂ nanocrystal networks are coated with nanoparticles of Mg(BH₄)₂, which has a theoretical hydrogen storage capacity of 14.8 wt. %. In this particular embodiment, at least about 10 weight % of the metal hydride is suitable. Alternative metal hydride nanoparticle coating materials include Ca(BH₄)₂, Al(BH₄)₃, Ti(BH₄)₃ and related compounds. Carbon may also be mixed with the metal hydride in the nanoparticle coatings. In addition, nanoporous oxide networks other than TiO₂ nanocrystals can be used as the network structure.

According to a fourth strategy, depicted in FIG. 4, ultralow-density TiO₂ networks can be intercalated with hydrides and amides X. In this case, the active gas (e.g., hydrogen) storage material X would fill a significant portion of the nanopore space of the oxide network. Catalysts can also be added to the intercalated structure. These are referred to herein as CAON-4 materials.

In specific embodiments of CAON-4 materials, in which the oxide network is intercalated with high-capacity complex hydrides and amides, metal hydrides such as Mg(BH₄)₂, NaBH₄, Ca(BH₄)₂, Li₃AlH₆ or LiNH₂ are intercalated with SiO₂ or TiO₂ networks. The primary structural difference between CAON-3 and CAON-4 materials is that the nanopores of the oxide network are mostly filled with the high capacity complex hydride or amides, forming an intercalated CAON-4 structure, while nanoparticles of metallic or hydride compound are coated onto the nanostructures of the oxide network in CAON-3 materials.

Coated inorganic nanoparticle network materials in accordance with the present invention can hold hydrogen in an amount of at least 5 weight %; or at least 10 weight %, or up to 15 weight % or more.

One advantage of using ultralow-density oxide network materials is that the size of the nanopores of the network structure, the composition and functionality of the oxide network materials, and those of the coating nanoparticles or thin films can be readily tuned by modifying synthesis parameters, such as varying the mixtures of precursors during preparation (sol-gel stage).

### Fabrication Methods

Techniques for the fabrication of many metal oxide aerogels are well known in the art. In one example, a porous SiO₂ aerogel or nanoparticle network can be formed by pH-dependent hydrolysis and condensation of an alkoxysilane in alcohol solution followed by CO₂ substitution and supercritical drying.

In specific embodiments, gas storage materials in accordance with the present invention, such as the various CAON strategies described above, may be prepared by depositing coatings on inorganic nanoparticle networks. An oxide aerogel material can be coated inside and out with a metal, metal hydride, or carbon vapor or gas phase precursor. The materials can be prepared using a two-step process: 1) formation of the aerogel or nanoparticle network, and 2) infilitrating the aerogel with the vapor or gas phase precursor to coat the nanoparticles in the aerogel. The coating may be accomplished by physical vapor deposition (PVD), such as thermal vaporization, pulse laser deposition, ion-beam sputtering, and others, or chemical vapor deposition (CVD) techniques, such as metal organic CVD, atomic layer deposition, and others. Such general techniques are well known in the art and one skilled in the art would be readily able to apply the techniques to coating nanoporous inorganic network materials given the disclosure provided herein.

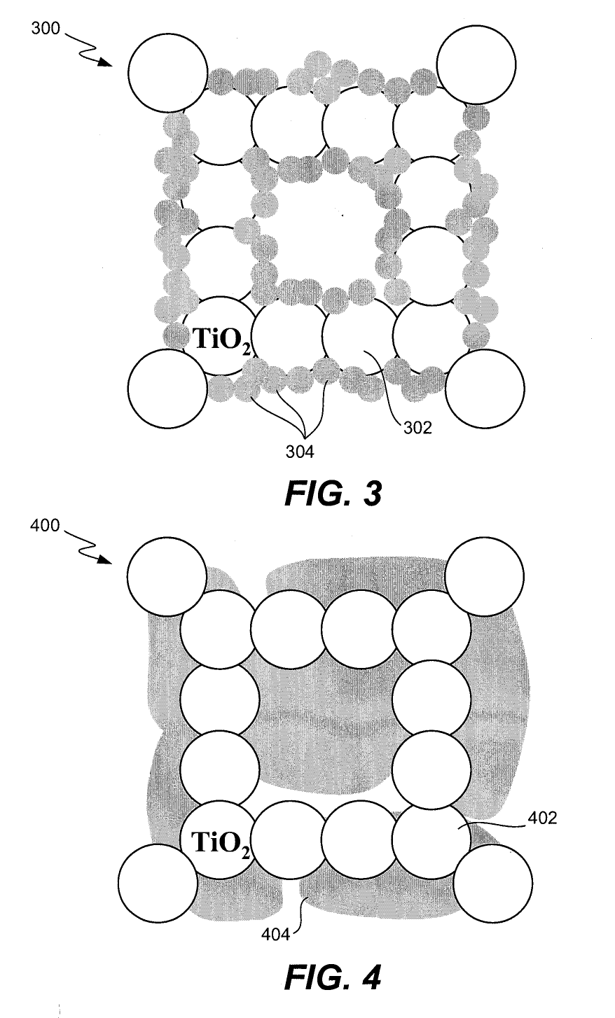

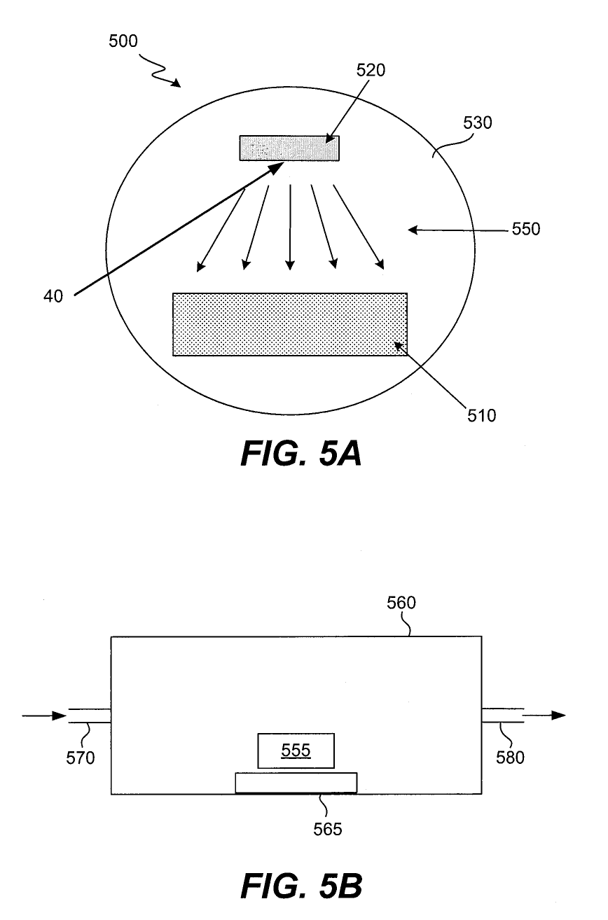

For example, FIG. 5A is a schematic drawing of a PVD system 500 that can be used to coat the inorganic nanoparticle networks (e.g., aerogel) in accordance with the present invention. The aerogel sample 510 and a target 520 made of a metal or alloy (e.g., MgNi, Pd, Pt, Au, Li, B, Ca, Ni, Ti), a metal hydride, carbon or any material that can act as a catalyst or capacity for adsorbing or absorbing a gas are placed in a high vacuum chamber 530. A pulsed laser 540 is positioned to vaporize the target 520. Alternatively, the target may be vaporized thermally. Vapor 550 from the target 520 infiltrates the aerogel sample 510, coating the inorganic nanoparticles that make up the aerogel.

Alternatively, a CVD system 550, schematically depicted in FIG. 5B can be used to coat the inorganic nanoparticle networks (e.g., aerogel) in accordance with the present invention. The aerogel sample 555 is placed in a CVD chamber 560 on a heated pedestal 565. Gas phase organic precursors, which are readily commercially available, for example from Sigma-Aldrich, for a metal or alloy (e.g., MgNi, Pd, Pt, Au, Li, B, Ca, Ni, Ti), a metal hydride, carbon or any material that can act as a catalyst or capacity for adsorbing or absorbing a gas are flowed into the chamber through an inlet 570. The gas phase precursors infiltrate the aerogel and react to deposit the metal, alloy or other material, coating the inorganic nanoparticles that make up the aerogel. The chamber also includes an outlet 580 for exhaust gases.

With either of these systems, and given the disclosure provided herein, a skilled artisan can make a hydrogen storage material, for example, according to strategies CAON-1, CAON-2 and CAON-3, described above. Prior to deposition of the coating, inorganic nanoparticle network structures, i.e., silica or titania aerogels, are composed of a linked three-dimensional network of oxide nanoparticles, generally 3-5 nm in diameter, and a system of open nanopores much smaller than the wavelength of visible light (i.e., a few hundred nanometers). In a PVD deposition embodiment, depending on the vaporization conditions, in addition to the vapor, pulsed laser irradiation of the target material may also generate nanoparticles made of the target material, which distribute throughout the coated nanoporous inorganic material.

In making CAON-4 materials, the coating or coating precursor compound, such as metal hydride or carbon, can be incorporated during the aerogel forming process (e.g., before CO₂ supercritical drying). This is different from the synthesis method for CAON-3 and the other materials, which are based on vapor infiltration into the nanoporous oxide networks. Therefore, as noted above, the primary structural difference between CAON-3 and CAON-4 materials is that the nanopores of the oxide network are mostly filled with the high capacity complex hydride or amides, forming an intercalated CAON-4 structure, while nanoparticles of metallic or hydride compound are coated onto the nanostructures of the oxide network in CAON-3 materials.

### Devices

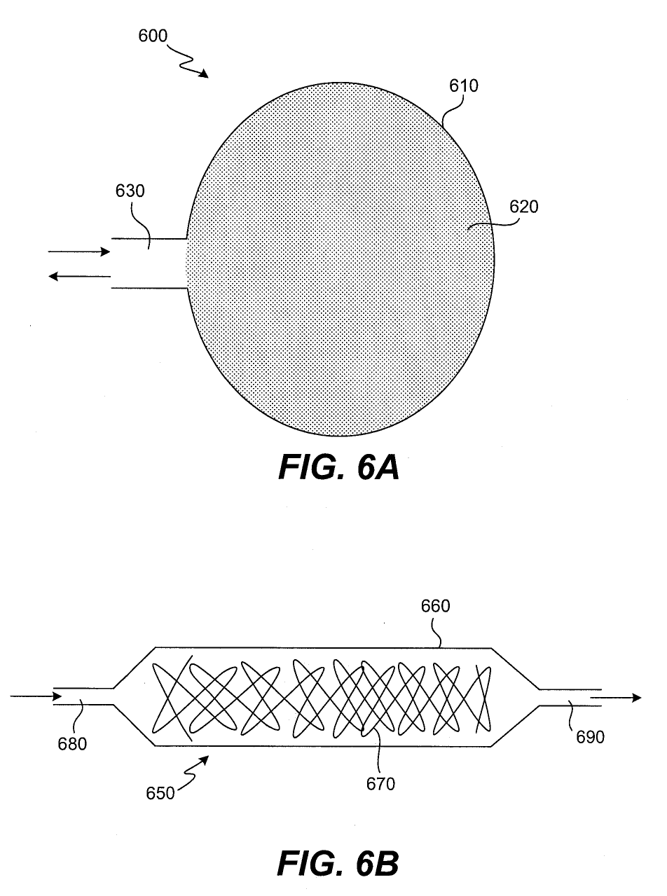

FIG. 6A is a schematic drawing of a gas storage device, according to an embodiment of the invention. The storage device 600 has a vessel 610 that contains a coated inorganic nanoparticle network material (nanoporous network of nanoparticles coated with metal, metal hydride, carbon, etc.) 620 as described herein. The vessel can be made of a robust material capable of withstanding temperatures and pressures suitable for gas storage. It is typically made of metal such as steel or brass and can withstand temperatures up to at least 300° C. and pressures up to about 80 or 100 or 200 bar. A fitting 630 on the vessel 610 provides a conduit through which gas can enter and exit the vessel 610. The fitting 630 can contain more than one conduit (not shown)—one or more for filling and one or more for emptying the vessel. The fitting can contain one or more valves. The coated nanoporous inorganic network material can have an inorganic network made of SiO₂, TiO₂, or other nanoparticles. The inorganic network can be in the form of an aerogel or nanocrystal materials, for example. The coating on the inorganic network nanoparticles can be a single metal or alloy, a metal hydride, carbon, or other materials as discussed above. The device 600 can be used to store gases such as hydrogen, CO₂, ammonia, or combinations thereof.

In another embodiment of the invention, shown schematically in FIG. 6B, a hydrogen (or other gas) storage device 650 includes a flow-through vessel 660 capable of withstanding pressures suitable for gas storage, a nanoporous network of SiO₂ or other composition nanoparticles coated with MgNi (or other coating material) 670 as described herein inside the vessel, a fitting 680 configured to allow hydrogen (or other gas) to enter the vessel 650, and a fitting 690 configured to allow hydrogen (or other gas) to leave the vessel 660.

### Storage Methods

In another embodiment of the invention, a method of storing gas includes providing a coated inorganic nanoparticle network material, introducing gas into the network at a pressure between approximately 1 bar and 100 bar and at a temperature between approximately 77 K and 400° C. Gas can be removed from the device by controlled heating using a resistance heater or similar apparatus integrated with the container (not shown). Desorption of gases from the coated inorganic nanoparticle network materials of the present invention can occur at lower temperatures (e.g., about 200° C. or less in some cases) than with bulk materials, a significant benefit in many practical applications of the technology.

In specific embodiment of the invention, a method of storing hydrogen includes providing a nanoporous network of SiO₂ nanoparticles coated with MgNi, introducing hydrogen into the network at a pressure between approximately 1 bar and 100 bar and at a temperature between approximately 77 K and 400° C.

### Applications

The new class of nanostructured inorganic materials described herein are capable of storing gases at various temperatures under safe pressures. The coated nanoporous inorganic network materials can be fabricated into a wide variety of shapes and sizes, so storage vessels containing these materials can be used in a wide variety of applications—for the very small (e.g., computers, cell phones, personal electronics, etc.) and for the very large (e.g., automobiles, power generators, etc.). Coated nanoporous inorganic network materials can also be formed in planar configurations, which allows for great flexibility in placement within a device. Scaling up to a manufacturing scale is straightforward. Thus, coated nanoporous nanostructured inorganic network materials represent an excellent alternative to currently-used porous metal-organic frameworks for solid-state hydrogen (and other gas) storage.

### EXAMPLES

The following examples provide details illustrating process specifics, advantageous properties and applications in accordance with the present invention. These examples are provided to exemplify and more clearly illustrate aspects of the present invention and are in no way intended to be limiting.

### Example 1

### Storage Capacity Increase Through Coating

The total surface areas of a pure SiO₂ nanoparticle network and a coated (with MgNi) nanoporous inorganic SiO₂ network material made in accordance with the present invention was tested. Surface area measurements were made with a Brunauer, Emmett and Teller (B.E.T.) instrument using nitrogen gas. The pure network had a surface area of approximately 850±50 m²/g while the coated network had a surface area of 950±50 m²/g. The increased surface area corresponds to increased gas storage capacity.

### Example 2

### Hydrogen Sorption and Desorption

Using a gas sorption characterization system dedicated to testing hydrogen storage capacity of nanostructured materials (Intelligent Gas Analyzer, Hiden Isochema), hydrogen gas uptake by pure SiO₂ nanoparticle network and nanoporous MgNi:SiO₂ network materials at conditions comparable to a typical application environment, i.e., at room temperature and pressures considered safe for transportation applications, was tested. The Intelligent Gas Analyzer is an instrument utilizing a precise scale with a weight resolution of 0.1 μg, and capable of controlling the temperature and pressure within its sample chamber. The testing procedure includes sealing the sample in a hydrogen reactor tube chamber, degassing the chamber using turbo-rotary vane pump combination (Alcatel ATP and BOC Edwards XDS) to achieve high vacuum, increasing hydrogen pressure at isothermal condition, and monitoring the mass change over time due to hydrogen sorption and desorption by the material.

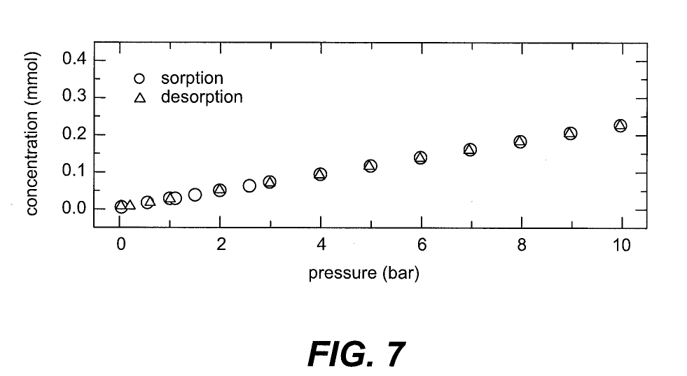

FIG. 7 is a graph showing hydrogen concentration as a function of pressure for a nanoporous MgNi:SiO₂ network material in accordance with this invention at room temperature showing that the material is capable of storing and releasing hydrogen. The estimated absolute hydrogen storage capacity for this sample, including adsorbed, absorbed, and trapped in the nanopores, was approximately 8 wt. %.

### Example 3

### Hydrogen Storage

Nanoporous metal-inorganic network materials were synthesized for use in hydrogen storage. At 20 bar pressure, a nanostructured network of composition MgNi:SiO₂ had hydrogen uptake of 7.5 weight % at 77 K and 1.55 weight % at room temperature. While physisorption dominates hydrogen sorption at low temperatures, contribution of chemisorption emerges as the temperature of metal-inorganic network materials is increased. At 350° C. and 20 bar, nanoporous MgNi:SiO₂ networks exhibit 2.15 weight % hydrogen uptake, compared to 1.4 weight % for nanoporous SiO₂ without the addition of metal. Nanoporous metal-inorganic network materials show promise as practical and useful hydrogen storage media with the possibility of tuning the storage capacity through careful design of the structure and composition of the networks.

### CONCLUSION

The realization of ultralow density, all-inorganic nanoparticle network offers a new class of nanostructured material for solid-state storage of hydrogen and other gases. The very large free volume in nanoporous oxide aerogels provides ample space for material modification to further increase the gas storage capacity through either physisorption or combined with chemisorption mechanism. In addition, the possibility of scale-up and cost-effective production of nanoporous oxide network materials makes these them attractive for practical hydrogen or other gas storage applications. Materials and associated devices and methods for solid state storage of hydrogen and other gases that achieve higher concentrations of stored gas more readily released for use that with prior approaches are described.

While the embodiments of the invention are primarily described and illustrated in the context of hydrogen storage in a nanoporous inorganic network, such as Pd-titania aerogel or MgNi-silica aerogel, those skilled in the art will appreciate readily that the materials, devices and methods disclosed herein will have application in a number of other contexts where gas storage is desirable, particularly where high efficiency and light weight are important. Almost any media that can form a light weight nanoporous network with high surface area can be used. Depending on the particular coating-inorganic nanoparticle network material used, a variety of gases such as hydrogen, CO₂ and ammonia can be stored by the materials, devices and methods described herein.

Although the foregoing invention has been described in some detail for purposes of clarity of understanding, certain changes and modifications will be apparent to those of skill in the art. It should be noted that there are many alternative ways of implementing both the process and materials and apparatuses of the present invention. Accordingly, the present embodiments are to be considered as illustrative and not restrictive, and the invention is not to be limited to the details given herein.

1. A hydrogen storage material, comprising:
an inorganic nanoparticle network; and
an inorganic coating on the inorganic nanoparticle network;
wherein at least one of the network and the coating comprises a catalyst for sorption of hydrogen.

2. The material of claim 1 wherein the inorganic nanoparticle network comprises SiO₂ or TiO₂.

3. The material of claim 1 wherein the inorganic nanoparticle network comprises an aerogel.

4. The material of claim 1 wherein the coating comprises a material selected from the group consisting of metals, alloys, metal hydrides, carbon, and other material that can act as a catalyst for sorbing hydrogen or provide hydrogen storage capacity.

5. The material of claim 1, wherein the network comprises a silica or titania aerogel and the coating comprises catalyst nanoparticles.

6. The material of claim 5, wherein the nanoparticles are selected from the group consisting of MgNi, Pd, Pt, Au and Ni and combinations thereof.

7. The material of claim 5, wherein the network comprises a titania aerogel and the coating comprises Pd nanoparticles.

8. The material of claim 5, wherein the network comprises a silica aerogel and the coating comprises MgNi nanoparticles.

9. The material of claim 1, wherein the network comprises a silica or titania aerogel and the coating comprises a film of a layered structure material and catalyst nanoparticles.

10. The material of claim 9, wherein the layered structure material is selected from the group consisting of graphite-like carbon, layered hydride and layered metal and combinations thereof.

11. The material of claim 10, wherein the network comprises a titania aerogel and the coating comprises a graphite-like carbon film and Pd nanoparticles.

12. The material of claim 1, wherein the network comprises a material having catalytic activity and the coating comprises a material having hydrogen storage capacity.

13. The material of claim 12, wherein the network material is natively catalytic.

14. The material of claim 12, wherein the network material is doped with a catalyst.

15. The material of claim 12, wherein the coating comprises metal hydride.

16. The material of claim 15, wherein the metal hydride is selected from the group consisting of Mg(BH₄)₂, Ca(BH₄)₂, Al(BH₄)₃ and Ti(BH₄)₃ and combinations thereof.

17. The material of claim 13, wherein the network comprises a titania aerogel and the coating comprises Mg(BH₄)₂.

18. The material of claim 12, wherein the coating is intercalated with the network material.

19. The material of claim 17, wherein the coating is intercalated with the network material.

20. The material of claim 1, further comprising sorbed hydrogen in an amount of at least 5 weight %.

21. The material of claim 1, further comprising sorbed hydrogen in an amount of at least 7.5 weight %.

22. The material of claim 1, further comprising sorbed hydrogen in an amount of at least 10 weight %.

23. The material of claim 1, further comprising sorbed hydrogen in an amount of at least 15 weight %.

24. A gas storage material, comprising:
an inorganic nanoparticle network; and
an inorganic coating on the inorganic nanoparticle network;
wherein at least one of the network and the coating comprises a catalyst for sorption of a gas to be stored.

25. The material of claim 24, wherein the gas is selected from the group consisting of hydrogen, ammonia and carbon dioxide.

26. A gas storage device, comprising:
a vessel;
a material according to claim 24 inside the vessel; and
a fitting on the vessel, the fitting configured to allow gas to enter and leave the vessel.

27. A hydrogen storage device, comprising:
a vessel capable of withstanding pressures up to about 100 bar and pressures up to 300° C.;
a material according to claim 1 inside the vessel; and
a fitting on the vessel, the fitting configured to allow hydrogen to enter and leave the vessel.

28. A method of making a hydrogen storage material, comprising:
forming an inorganic nanoparticle network; and
depositing an inorganic coating on the inorganic nanoparticle network;
wherein at least one of the network and the coating comprises a catalyst for sorption of hydrogen.

29. The method of claim 28, wherein the deposition is by one of PVD and CVD.

30. A method of storing hydrogen, comprising:
providing a material according to claim 1;
introducing hydrogen into the material.
